(19) United States
(12) Patent Application Publication
(10) Pub. No.: US 2009/0018194 A1
(43) Pub. Date: Jan. 15, 2009

(54) Use of antimicrobial agents derived from alliaceous plants for the prevention and control of crop diseases, post-harvest rot and as environmental disinifectant products

(75) Inventors: Maria Pilar Garcia-Pareja, Alhendin (Granada) (ES); Eduardo Sanchez-Vaquero, Alhendin (Granada) (ES); Enrique Guillamon Ayala, Alhendin (Granada) (ES); Felix Martinez Lopez, Alhendin (Granada) (ES)

Correspondence Address: Davidson, Davidson & Kappel, LLC, 485 7th Avenue, 14th Floor, New York, NY, 10018, US

(73) Assignee: DMC Research Center, S.L., Alhendin (Granada) (ES)

(21) Appl. No.: 12/219,136

(22) Filed: Jul. 11, 2008

(30) Foreign Application Priority Data
Jul. 12, 2007 (ES) P200701954

(51) Int. Cl. A01N 41/04; A01P 1/00

(52) U.S. Cl. 514/553

(57) ABSTRACT

The present invention is directed to utilization of antimicrobial agents derived from plants of the alliaceae family for the prevention and control of crop diseases, post-harvest rotting and as environmental disinfection products. The agents include propyl propylthiosulfinate and propyl propylthiosulfonate compounds for pre- and post-harvest treatments, control of rotting in fruits and vegetables; disinfection of agricultural soils, control of microorganisms, environmental disinfection in agricultural processing industries, facilities and equipment, disinfection of food containers and boxes. The agents can be used as pure active principles or in mixtures, in aqueous solutions or in any formulation, either liquid or supported in a solid agent or formulation; as single active principles or in formulation, together with other synthetic or natural antifungal agents, biocontrol agents, fertilizers, antioxidants, growth regulators or regulators of any other type; by means of immersion, fogging, wetting, spraying, atomization, injection in the soil, in irrigation systems, by means of drenchers or in general any other treatment or application system.

This application claims priority from Spanish Patent Application No. P200701954 filed Jul. 12, 2007, the disclosure of which is hereby incorporated by reference in its entirety.

### SCOPE OF THE INVENTION

This invention is applicable in the food processing industry and especially in the agricultural industry which requires phytosanitary treatments of natural origin that minimize the losses to the harvest from diseases or from rotting during the storage of the harvest.

Likewise, the invention can also be used in industries that require treatments for the disinfection of facilities using natural agents, including cold rooms, walls, floors, equipment and boxes of fruit containers.

### BACKGROUND OF THE INVENTION

Plants of the genus Allium, such as garlic (Allium sativum L) or onions (Allium cepa L.) have been used as food for thousands of years, but also as curatives because they are very effective and have few if any side effects. Their antimicrobial characteristics are very well known and have been extensively described since Cavallito and Bailey isolated some of the compounds responsible for these properties in 1944 and identified allicin (allyl allylthiosulfinate) as an antibacterial agent.

Subsequent studies have shown that the thiosulfinates are decomposed and/or transformed into other compounds of the types including thiosulfonates, sulfides, sulfoxides etc. that have similar biological effects. There are references to the antimicrobial capacity of natural thiosulfonates and their potential applications, although mention should also be made of the industrial use of some non-natural thiosulfonates such as hydroxypropyl methyl thiosulfonate (HPMTS), which is used for the preservation of paints, varnishes and cooling tower water, or bensultap, which is used as an insecticide.

The compounds of natural origin of the thiosulfinate or thiosulfonate type can therefore represent a real and effective alternative to the synthetic chemical products used to combat the pests that affect crops and the post-harvest products that are applied to prevent or reduce rotting.

The need for this application is more than justified, because the intensive and extensive use of synthetic pesticides creates a risk to human health and the environment. An additional problem is the continuous appearance of resistance to these synthetic pesticides in certain pathogenic fungi.

Nevertheless, there have not been many experiments or articles to date that describe this potential application. There are some references to the use of sulfur compounds as antimicrobials in agricultural treatments, but in no case is there any reference to the two specific compounds claimed by this patent.

The bibliographic search conducted has identified studies on extracts of garlic (individually or mixed with other extracts or natural oils) for fumigation treatments or the control of rotting. Note should be taken of the following patents and references:

CN1698440, which refers to a formulation of acetamiprid and garlic oil, and to its use for the prevention of various agricultural pests.

EP 0945066, which describes a synergistic effect when garlic oil or garlic extract is combined with other essential oils (cinnamon, rosemary, tea, orange, etc.), thereby improving its effectiveness as a fungicide and insecticide.

“Control of citrus green and blue molds with garlic extracts,” (J. Obagwu, L. Korsten, European Journal of Plant Pathology. 109, 221-225, 2003), which describes the effectiveness of garlic extracts in water and ethanol for the control of citrus rot caused by Penicillium digitatum and Penicillium italicum.

In the case of sulfides, note should be taken of Patents FR 2779615A1 and JP 7126108. In the first case, the patent relates to a fumigation agent that contains sulfides and is used against parasites and, in the second case, a formulation that promotes germination.

The prior art also describes the use of allicin (allyl thiosulfinate) in disinfection and agricultural treatments. There are numerous references describing its use, for example as an insecticide in US2006110472, as a disinfectant and biocide in EP 1617731 or for the protection of soil against pathogens in US2004082479.

Nevertheless, with regard to other thiosulfinates, or to the thiosulfonates as a group, we have not found any bibliographical references to their use as treatments against agricultural diseases or post-harvest rotting.

Nor have any references been found that describe the potential use of these compounds as environmental disinfection agents. This type of disinfection is an essential aspect in the food processing industry, where the contamination of facilities and equipment creates a risk, in addition to considerable reductions of productivity and the quality of the final product.

The advantages that can be achieved by the use of these compounds in industrial disinfection (environments, cold rooms, floors, containers for fruits and vegetables or walls) are obvious, because they can replace the products that are conventionally used for this purpose, which in the majority of cases can be toxic or cannot be applied in the presence of foods. On the other hand, the products claimed by the invention are a natural alternative, exhibit a broader spectrum of activity and have a low level of toxicity, which means that they can come into contact with the food without creating any danger to health, as a result of which is not necessary to remove the food in question from the facility. This not only achieves a significant savings of time and money, but also makes it possible to perform sequential or periodic treatments, which will make it possible to achieve greater long-term efficiency.

The applicant is aware of the existence of patent JP 62263121A as well as other publications that describe the activity of ajoene against pathogenic fungi such as Fusarium sp., Rhizoctonia sp. or Penicillium italicum, although ajoene is a sulfoxide-type compound with a chemical nature that is different from the thiosulfinates and thiosulfonates claimed by the invention.

The applicant would also like to mention the existence of its own patent EP 1721534, which claims the use of extracts and compounds derived from plants of the genus Allium as preservatives in the food and food processing industry. The object of the previous patent was preservation in the food processing industry (with special importance in the dairy and meat products sectors, and the applicant has designed the current invention specifically for the agricultural sector, with new exemplary applications: field tests to combat various phytopathogens, post-harvest treatments, disinfection of containers, etc.

### OBJECTS AND SUMMARY OF THE INVENTION

This invention, as explained in the descriptive portion of this application, relates to the use of antimicrobial agents derived from plants of the Alliaceae family for the prevention and control of crop diseases, post-harvest rotting and as environmental disinfectant products.

More specifically, the object of the invention involves the utilization of compounds from plants of the genus Allium, specifically propyl propyl thiosulfinate and propyl propylthiosulfonate, as antimicrobial agents in pre-harvest and post-harvest treatments, environmental and soil disinfection, as a natural and effective alternative to the use of synthetic pesticides, fungicides or disinfectants.

It is also an object of the present invention to provide a method of using antimicrobial agents derived from plants of the alliaceae family for the prevention of crop diseases, control of crop diseases, prevention of post-harvest rotting, control of post-harvest rotting, and/or as environmental disinfection products, comprising contacting an intended substrate with an agent selected from group consisting of propyl propylthiosulfinate (PTS), (ii) propyl propylthiosulfonate (PTSO), and (iii) propyl propylthiosulfinate (PTS) and propyl propylthiosulfonate (PTSO).

In certain other embodiments, the present invention is directed to a method of using antimicrobial agents derived from plants of the alliaceae family for the prevention and/or control of pre-harvest crop diseases comprising contacting an intended substrate with an agent selected from group consisting of (i) propyl propylthiosulfinate (PTS), (ii) propyl propylthiosulfonate (PTSO), and (iii) propyl propylthiosulfinate (PTS) and propyl propylthiosulfonate (PTSO).

In certain other embodiments, the present invention is directed to a method of using antimicrobial agents derived from plants of the alliaceae family for the prevention and/or control of post-harvest rot in fruits and/or vegetables comprising contacting the fruits and/or vegetables with an agent selected from group consisting of (i) propyl propylthiosulfinate (PTS), (ii) propyl propylthiosulfonate (PTSO), and (iii) propyl propylthiosulfinate (PTS) and propyl propylthiosulfonate (PTSO).

In certain other embodiments, the present invention is directed to a method of using antimicrobial agents derived from plants of the alliaceae family for the prevention and/or control of post-harvest rot in fruits and/or vegetables and to prolong their shelf life (during the phases of storage, transport and sale), comprising contacting the fruits and/or vegetables with an agent selected from group consisting of (i) propyl propylthiosulfinate (PTS), (ii) propyl propylthiosulfonate (PTSO), and (iii) propyl propylthiosulfinate (PTS) and propyl propylthiosulfonate (PTSO).

In certain other embodiments, the present invention is directed to a method of using antimicrobial agents derived from plants of the alliaceae family for the environmental disinfection treatments of agricultural soils, for the control of microorganisms and/or other biotic factors that affect crops comprising contacting the agricultural soils with an agent selected from group consisting of (i) propyl propylthiosulfinate (PTS), (ii) propyl propylthiosulfonate (PTSO), and (iii) propyl propylthiosulfinate (PTS) and propyl propylthiosulfonate (PTSO).

In certain other embodiments, the present invention is directed to a method of using antimicrobial agents derived from plants of the alliaceae family for the environmental disinfection treatments in food processing industries such as rooms, greenhouse, etc., and/or machinery and/or equipment that come in contact with food comprising contacting the rooms, greenhouse, etc., and/or machinery and/or equipment that come in contact with food with an agent selected from group consisting of (i) propyl propylthiosulfinate (PTS), (ii) propyl propylthiosulfonate (PTSO), and (iii) propyl propylthiosulfinate (PTS) and propyl propylthiosulfonate (PTSO).

In certain other embodiments, the present invention is directed to a method of using antimicrobial agents derived from plants of the alliaceae family for the environmental disinfection treatments of containers, pallets, storage boxes and/or crates (made of wood, plastic and/or other materials) for fruit and other foods, comprising contacting the containers, pallets, storage boxes and/or crates (made of wood, plastic and/or other materials) for fruit and other foods with an agent selected from group consisting of (i) propyl propylthiosulfinate (PTS), (ii) propyl propylthiosulfonate (PTSO), and (iii) propyl propylthiosulfinate (PTS) and propyl propylthiosulfonate (PTSO).

In accordance with any of the above objects, the invention is further directed to methods wherein the agent or agents can be applied as pure active principles or in mixtures, in aqueous solutions of any concentration, in emulsions or, in general, in any formulation, both in the liquid state or supported in a solid agent or formulation.

In accordance with any of the above objects, the invention is further directed to methods wherein the agent or agents can be applied as single active principles or in a formulation together with other synthetic or natural antifungal agents, biocontrol agents, coating agents (natural or synthetic), fertilizers, antioxidants, growth regulators or regulators of any other type.

In accordance with any of the above objects, the invention is further directed to methods wherein the agent or agents can be applied for said purposes by means of immersion, fogging, wetting, spraying, atomization, injection into the soil, in irrigation systems, by means of drenchers or, in general, any other treatment or application system.

### DETAILED DESCRIPTION OF THE INVENTION

Adequate control of the diseases that affect harvests during handling in the field as well as rotting during post-harvest storage is fundamental to minimizing the losses caused by these alterations. It is estimated that, in the developed countries, approximately 15% of total agricultural production is lost for these reasons, while in the developing countries these losses can account for up to 40% of total production.

Traditionally, the utilization of synthetic chemical products has been the most widely used system for the control of these types of rot, although in reality, social requirements have led to the demand for less aggressive agriculture methods that do not use toxic agrochemicals. There are ever increasing objections to these agents by consumers, who prefer the use of natural products.

In addition, the development of resistance by certain fungi to the traditional chemical fungicides, the persistence of residues of pesticides in fruits and vegetables and their potential negative effects on human health (given the carcinogenic and teratogenic potential of some of them), has led some governments to restrict the use of authorized products for these purposes and the establishment of some very strict maximum limits on residues (LMR).

Therefore, a real demand exists for the development of new and effective methods of control of agricultural diseases that are acceptable to public opinion because they do not pose any risk to human health and the environment. Among these alternatives are treatments with non-specific biocontrol or antifungal agents (such as bicarbonates or sorbic acid). But another possibility that can be considered here, is the treatment with natural anti-microbials that are present in plants, are highly effective and have a broad spectrum of activity, and which, because when used as active ingredients, do not pose any risk to the safety of the food supply.

In this sense, the compounds of the thiosulfinate or thiosulfonate type, which are present in plants of the genus Allium (garlic, onions, leeks and other plants), are highly effective, have no undesirable side effects and can therefore represent a real and effective alternative to the phytosanitary agents that are conventionally utilized to mitigate diseases and rotting of agricultural products, with the advantage that they lack the toxic characteristics of these phytosanitaries and do not cause any problems in terms of residues.

Specifically, this invention proposes the utilization of antimicrobial agents derived from plants of the family Alliacaea for the prevention and control of crop diseases and post-harvest rot and for environmental disinfection. Specifically, the compounds protected by the invention are the following:

Propyl Propyl Thiosulfinate (Hereinafter Referred to as PTS)

Propyl Propyl Thiosulfonate (Hereinafter Referred to as PTSO)

These compounds have been shown to be suitable for use in pre- and post-harvest treatments, to notably reduce the diseases and rotting caused by different phytopathogens.

Some of the “in vitro” and “in vivo” tests conducted to demonstrate the effectiveness of both products in different applications are described below.

A. The “in vitro” antimicrobial activity of these compounds was tested (referenced as PTS and PTSO), at different doses, as well as their activity against a broad spectrum of bacteria, fungi and yeasts. The tests were conducted against standard micro-organisms (reference strains from different collections of standard crops) and also against wild strains isolated from different types of rot and fruits and other affected crops.

These tests of antimicrobial capacity were conducted according to the agar diffusion technique, using cellulose discs 6 mm in diameter, impregnated with the different doses under study. For the assessment of the anti-fungal capability, the medium Sabouraud glucosate agar 2% was used, inoculated with suspensions of spores prepared to a concentration on the order of 10⁸ cells/ml. To assess the antibacterial capability, the cultivation medium Müller-Hinton agar was used, inoculated with suspensions of bacteria prepared to a concentration of 10⁶ cells/ml.

Once the plates were inoculated, the discs previously impregnated with the different test doses of each of the compounds to be analyzed were put in place. The reading was taken after incubation of the plates by measuring the zone of inhibition that appeared, and the result was expressed in mm corresponding to the diameter of the halo that appeared (including the 6 mm of the cellulose disc). The results of these tests are presented below.

The data corresponding to the tests with master strains are presented in Tables 1 and 2.

TABLE 1
Activity of PTS against various microorganisms from
culture collections.

| Microorganisms tested | Dose of active principle | | |
|---|---|---|---|
| (reference strains) | 100 ppm | 50 ppm | 25 ppm |
| Micrococcus luteus | 32 | 25 | 19 |
| ATCC 15307 | | | |
| Bacillus megaterium | 34 | 27 | 23 |
| ATCC 33085 | | | |
| Listeria monocytogenes | 30 | 24 | 18 |
| CECT 4032 | | | |
| Escherichia coli | 21 | 17 | 14 |
| CECT 515 | | | |
| Candida magnoliae | 38 | 30 | 22 |
| DSMZ 70638 | | | |
| Candida krusei | 29 | 18 | 14 |
| ATCC 34135 | | | |
| Candida parapsilosis | 17 | 14 | 0 |
| CCTM 1038 | | | |
| Saccharomyces cerevisiae | 44 | 32 | 28 |
| CECT 1324 | | | |
| Penicillium italicum | 34 | 26 | 22 |
| CECT 2294 | | | |
| Aspergillus terreus | 25 | 22 | 12 |
| CECT 2663 | | | |
| Aspergillus niger | 19 | 13 | 10 |
| CECT 2700 | | | |

Data expressed in mm of diameter of the microbial inhibition halo developed for each test dose (including the 6 mm of the cellulose disc) against each strain.

TABLE 2
Comparative activity of PTS and PTSO against various
microorganisms from culture collections

| Microorganisms | | | | | | | | | | |
|---|---|---|---|---|---|---|---|---|---|---|
| tested | | | | | | | | | | |
| (reference | PTS (ppm) | | | | | PTSO (ppm) | | | | |
| strains) | 1000 | 500 | 250 | 125 | 60 | 1000 | 500 | 250 | 125 | 60 |
| Bacillus subtilis | 55 | 55 | 40 | 35 | 32 | 68 | 50 | 42 | 36 | 27 |
| ATCC 6633 | | | | | | | | | | |
| Bacillus cereus | 35 | 27 | 25 | 20 | 15 | 49 | 47 | 45 | 35 | 25 |
| ATCC 10876 | | | | | | | | | | |
| Enteroccus | 30 | 30 | 26 | 22 | 15 | 45 | 45 | 45 | 33 | 26 |
| faecalis | | | | | | | | | | |
| ATCC 29212 | | | | | | | | | | |
| Listeria innocua | 40 | 37 | 32 | 23 | 13 | 52 | 43 | 35 | 20 | 13 |
| CECT 4030 | | | | | | | | | | |
| Salmonella | 25 | 23 | 22 | 15 | 11 | 27 | 25 | 25 | 17 | 16 |
| typhimurium | | | | | | | | | | |
| ATCC 13311 | | | | | | | | | | |
| Escherichia coli | 27 | 25 | 24 | 17 | 12 | 29 | 27 | 26 | 19 | 18 |
| ATCC 25922 | | | | | | | | | | |
| Pseudomonas | 14 | 12 | 10 | 9 | 8 | 12 | 10 | 9 | 8 | 6.5 |
| aeruginosa | | | | | | | | | | |
| ATCC 9027 | | | | | | | | | | |
| Penicillium | 35 | 28 | 16 | 11 | 0 | 40 | 30 | 20 | 12 | 0 |
| solitum | | | | | | | | | | |
| Wild strain | | | | | | | | | | |

Data expressed in mm of diameter of the microbial inhibition halo developed for each test dose (including the 6 mm of the cellulose disc) against each strain.

On the basis of the data presented in the tables above, it is apparent that both products develop a broad spectrum of action, with a good inhibitory power, even at low doses.

Once the screening of the anti-microbial capability of the compounds claimed by the invention had been performed over a broad range of reference strains, their efficiency was corroborated against wild strains, which we isolated as specific pathogens that affect different crops of different geographic origins.

The results of some of these tests are presented in Tables 3 and 4, in which data on effectiveness against different isolated strains of the genera Penicillium, Colletotrichum, Fusarium and Phytophthora are included.

TABLE 3
Activity of PTS against various wild fungi isolated
from affected bananas.

| Microorganisms | | | | | | |
|---|---|---|---|---|---|---|
| tested | | | | | | |
| (wild, isolated | | | | | | |
| from crown rot | PTS (ppm) | | | | | |
| in bananas) | 1000 | 500 | 250 | 125 | 60 | 30 |
| Penicillium sp. | 20 | 18 | 15 | 11 | 0 | 0 |
| (CPC-PT-1) | | | | | | |
| Penicillium sp. | 25 | 25 | 15 | 0 | 0 | 0 |
| (CPC-PT-2) | | | | | | |
| Penicillium sp. | 17 | 15 | 13 | 10 | 0 | 0 |
| (CPC-PT-3) | | | | | | |
| Penicillium sp. | 25 | 23 | 20 | 13 | 11 | 0 |
| (CPC-PT-4) | | | | | | |
| Colletotrichum sp. | 43 | 43 | 40 | 30 | 20 | 10 |
| (CPC-PT-5) | | | | | | |
| Colletotrichum sp. | 45 | 48 | 47 | 35 | 30 | 20 |
| (CPC-PC-6) | | | | | | |
| Fusarium sp. | 35 | 25 | 25 | 15 | 0 | 0 |
| (CPC-PT-7) | | | | | | |
| Fusarium sp. | 20 | 20 | 15 | 12 | 10 | 0 |
| (CPC-PT-8) | | | | | | |
| Fusarium sp. | 33 | 30 | 15 | 0 | 0 | 0 |
| (CPC-PT-9) | | | | | | |
| Unidentified yeast | 65 | 63 | 55 | 50 | 45 | 40 |
| (CPC-PT-10) | | | | | | |

Data expressed in mm of diameter of the microbial inhibition halo developed for each test dose (including the 6 mm of the cellulose disc) against each strain.

TABLE 4
Activity of PTS against various wild phytopathogens
isolated from rotting in citrus fruit

| Strains tested | | | | | | |
|---|---|---|---|---|---|---|
| (wild, isolated | Dose of active principle (ppm) | | | | | |
| from citrus rot) | 1000 | 500 | 250 | 125 | 60 | 30 |
| Penicillium digitatum | 35 | 33 | 33 | 20 | 15 | 12 |
| Supplied by Brogdex SA | | | | | | |
| Penicillium digitatum | 41 | 40 | 33 | 20 | 15 | 12 |
| Wild strain | | | | | | |
| Supplied by UdL-IRTA | | | | | | |
| Penicillium italicum | 20 | 15 | 13 | 13 | 0 | 0 |
| Wild strain | | | | | | |
| Supplied by UdL-IRTA | | | | | | |
| Phytophthora citrophthora | 55 | 53 | 42 | 23 | 21 | 10 |
| CECT 2353 | | | | | | |

Data expressed in mm of diameter of the microbial inhibition halo developed for each test dose (including the 6 mm of the cellulose disc) against each strain.

A comparison of these data with the data obtained in treatments with some conventional phytosanitaries shows that the compounds derived from plants of the Alliacaea family can be used effectively as an effective natural alternative to these phytosanitaries (Compare Tables 3 and 4 to Tables 5 and 6). This field of application is particularly relevant on account of the total absence of natural commercial products that combine both a broad spectrum of activity with a good inhibitory action, even at low doses.

TABLE 5
Activity of commercial phytosanitaries against various microorganisms.

| | % active principle in the commercial product | | | | | | | | | | | |
|---|---|---|---|---|---|---|---|---|---|---|---|---|
| | Procloraz 40% | | | Thiabenzadole 45% | | | Guazatine 20% | | | Imazalil 50% | | |
| Microorganisms | Dose in ppm in the commercial product | | | | | | | | | | | |
| tested | 4000 | 2000 | 1000 | 4000 | 2000 | 1000 | 4000 | 2000 | 1000 | 4000 | 2000 | 1000 |
| Penicillium italicum | 35 | 35 | 31 | >40 | >40 | >40 | 15 | 12 | 10 | 50 | 47 | 46 |
| CECT 2294 | | | | | | | | | | | | |
| Geotrichum | 0 | 0 | 0 | 0 | 0 | 0 | 35 | 30 | 27 | 26 | 23 | 20 |
| candidum | | | | | | | | | | | | |
| CECT 1902 | | | | | | | | | | | | |
| Trichoderma | 12 | 11 | 8 | 26 | 26 | 24 | 35 | 30 | 25 | 31 | 25 | 20 |
| aureoviride | | | | | | | | | | | | |
| CECT 20102 | | | | | | | | | | | | |

Data expressed in mm of diameter of the microbial inhibition halo developed for each test dose (including the 6 mm of the cellulose disc) against each strain.

TABLE 6
Activity of commercial phytosanitaries against various microorganisms

| | o-pheynl | | | | Sodium o-phenyl | | | |
|---|---|---|---|---|---|---|---|---|
| Micro- | phenol | | Biphenyl | | phenate 30% | | | |
| organisms | Dose of active principle ppm | | | | | | | |
| tested | 6000 | 4000 | 6000 | 4000 | 6000 | 4000 | 2000 | 1000 |
| Penicillium | 45 | 45 | 8 | 7 | 53 | 33 | 30 | 20 |
| italicum | | | | | | | | |
| CECT 2294 | | | | | | | | |
| Geotrichum | 47 | 45 | 0 | 0 | 40 | 35 | 30 | 7 |
| candidum | | | | | | | | |
| CECT 1902 | | | | | | | | |
| Trichoderma | 42 | 40 | 0 | 0 | 35 | 20 | 10 | 0 |
| aureoviride | | | | | | | | |
| CECT 20102 | | | | | | | | |
| Rhizopus | 15 | 14 | 0 | 0 | 0 | 0 | 0 | 0 |
| stolonifer | | | | | | | | |
| ATCC 24862 | | | | | | | | |

Data expressed in mm of diameter of the microbial inhibition halo developed for each test dose (including the 6 mm of the cellulose disc) against each strain.

B. Likewise, numerous tests were conducted “in vivo” to determine the effectiveness of the products for pre- and post-harvest treatments, and also as disinfectant agents for agricultural soils and facilities in the food processing industries.

In post-harvest treatments, tests were conducted in strawberries, citrus fruits, stone fruits and tropical fruits. Tests were also conducted on vegetable plants in a greenhouse (tomatoes, melons, zucchini, peppers, cucumbers and green beans).

The majority of the data obtained in these tests show that the active principles PTS and PTSO have a high control capability against the most characteristic diseases that affect these crops, and are presented in the following table:

TABLE 7
Pre-harvest diseases in various crops against which the PTS and/or
PTSO are active.
Pre-harvest diseases in various crops against which the PTS and/or
PTSO are active.

| Crop | Pathogen | Disease |
|---|---|---|
| Garden produce | Pseudoperonospora cubensis, | Downy mildew |
| with edible fruits | phytophthora infestans | |
| and leaves: | | |
| Tomatoes, peppers, | | |
| cucumbers, melons, | | |
| lettuce, etc. | | |
| | Erysiphe sp., Sphaeroteca s.p, | Powdery mildew |
| | Leveillula taurica | |
| | Botrytis cinerea pers. | Botrytis (gray mold) |
| | Alternaria dauci | Alternariosis |
| Stone fruits | Venturia inaequalis | Spotted |
| | Erysiphe sp., Sphaeroteca sp., | Powdery mildew |
| | Leveillula taurica | |
| | Monilia fructicola, Monilia | Monilia |
| | laxa | |
| | Taphrina deformans | Bruised |
| Citrus fruits | Alternaria citri | Alternaria of |
| | | citrus fruits |
| | Phytophthora spp. | Gummosis |
| Strawberries | Phytophthora infestans | Downy mildew |
| | Oidium fragariae | Powdery mildew |
| | Botrytis cinerea pers. | Botrytis |
| Tropical fruits: | Pseudoperonospora cubensis, | Downy mildew |
| avocado, | Phytophthora spp., | |
| mango | | |
| | Colletotrichum gloesporioides | Anthracnosis |

Some of these tests were especially significant, such as the result against powdery mildew in peppers grown in greenhouses in Almeria. The relevance of the data obtained is based on the scarcity of effective and non-synthetic systems that control this disease (caused by Leveillula taurica).

In the case of this test, spray guns were used, via the greenhouse irrigation system, to apply solutions of 1000 ppm and 2000 ppm of PTS and PTSO, with a nutrient broth volume of 20, 30, 40 l/parcel, depending on the application. These solutions were distributed in parcels of 4 rows, located in the zone of the greenhouse with a greater incidence of powdery mildew, while a reference product was applied in the rest of the warehouse: Ciproconazol (Caddy 10 WG at 10 gr/100 l) for the first and second application, Triadimenol (Bayfidan 25 EC at 25 ml/100 l) for the third application and Ciproconazol/Triadimenol for the final application.

The fungicidal effectiveness of the products was such that, at doses of 1000 and 2000 ppm, the control of powdery mildew by PTS was similar to that achieved by the reference product, and was specifically 92% of the effectiveness of the reference product, while the effectiveness of PTSO was slightly lower.

In relation to the tolerance of the crop, it should be noted that no symptoms of phytotoxicity were observed, nor any harmful effects on the beneficial fauna on the plants.

The active principles claimed by this invention have also been demonstrated to be very effective in the control of diseases and rot in the post-harvest phase of various crops. Some of these diseases are presented in the following table.

TABLE 8
Post-harvest diseases in various fruits against which PTS and/or
PTSO are active.
Principal post-harvest diseases in various fruits against which
PTS and PTSO are active

| Fruits | Pathogen | Disease |
|---|---|---|
| Apples, pears and quince | Penicillium expansum | Blue mold |
| | Botrytis cinerea | Gray mold |
| | Physalospora obtusa | Black rot |
| | Glomerella cingulata | Sour rot |
| | Botryospheria ribis | White rot |
| Citrus fruit | Penicillium italicum | Blue mold |
| | Penicillium digitatum | Green mold |
| | Alternaria citri | Alternariosis |
| | Phomopsis citri | Bud rot |
| | Diplodia natalinsis | Bud rot |
| Grapes and small fruit | Penicillium expansum | Gray mold |
| | Botrytis cinerea | Blue mold |
| | Rhizopus stolonifer | Rhizopus rot |
| | Cladosporium herbarum | Cladosporium rot |
| Stone fruit | Monilinia spp. | Monilia rot |
| | Rhizopus stolonifer | Rhizopus rot |
| | Penicillium expansum | Blue mold |
| | Botrytis cinerea | Gray rot |

A third application in which the anti-microbials PTS and PTSO have been shown to be effective is the disinfection of agricultural soil, as a decontaminant prior to planting, by acting against bacteria, fungi and nematodes. Tests have been conducted to assess their effectiveness against Fusarium spp. in asparagus and against Ralstonia solanacearum in “in vitro” tests. In both cases, the application of the products PTS and PTSO was found to be highly effective.

This aspect is particularly important, given the lack of effective and non-synthetic disinfectants that protect fruit and vegetable crops such as strawberries, tomatoes, peppers, melons, etc. The problem is even greater since, due to their toxicity and effect on the ozone layer, a prohibition has been placed on the use of the products traditionally used for these purposes such as the halons and, in particular methyl bromide. Therefore, the development of non-toxic alternatives that are active against pathogens such as Verticillium dhaliae, Rhyzoctonia solani, Ralstonia solanacearum and Fusarium oxysporum becomes essential.

For example, fungi of the genus Fusarium are of major economic importance as crop pathogens, principally Fusarium oxysporum, which causes fusariosis. They are potential pathogens that are capable of surviving in the soil and feeding off decomposition materials.

This fungus is introduced into the plant via cracks, which can be caused by the working of the soil, mechanical handling and treatment, natural accidents, pest infestations, etc. At the level of the root system, the principal roots show a total absence of reserve substances, leaving the epidermis hollow.

After determining that doses of 2000 ppm do not cause phytotoxic effects, two field tests were conducted on affected asparagus (on two farms that contained a total of 600 plants, all affected by fusariosis) to assess the activity against Fusarium spp. in roots and soil. The treatment doses used were 250, 500 and 1000 ppm of both active principles (PT and PTSO), and the initial incidence of the pathogen was compared with its presence 60 days after its application.

To analyze the growth of the crops infected by Fusarium spp. after the treatments, root and soil samples were taken and tests were performed in the laboratory to investigate the incidence of the pathogen in the roots and soil. The cultivation media used were potato dextrose agar and rose bengal agar (to prevent the invasive character of the Mucoralean fungi).

The soil analysis was conducted by sequential dilutions of the soils in physiological serum with a subsequent sowing in the above mentioned media. The analysis of the roots was performed after dissection of the infected tissues, which were deposited in triplicate on filter paper located above both media, and their evolution over time was studied.

The results of this test are presented schematically in the following tables. The data are expressed as a percentage of elimination and reduction as a function of the treatment dose compared to the untreated control samples.

TABLE 9
Effectiveness of PTS and PTSO against Fusarium spp. in the soil.

| Effectiveness of the | PTS (ppm) | | | PTSO (ppm) | | |
|---|---|---|---|---|---|---|
| products on the SOIL | 250 | 500 | 1000 | 250 | 500 | 1000 |
| % elimination | 100 | 87.5 | 100 | 85 | 75 | 100 |
| % reduction | 0 | 12.5 | 0 | 15 | 25 | 0 |

TABLE 10
Effectiveness of PTS and PTSO against Fusarium spp. in roots.

| Effectiveness of the | PTS (ppm) | | | PTSO (ppm) | | |
|---|---|---|---|---|---|---|
| products on the SOIL | 250 | 500 | 1000 | 250 | 500 | 1000 |
| % elimination | 0 | 57 | 58 | 33 | 86 | 57 |
| % reduction | 60 | 14 | 13 | 25 | 14 | 43 |

Note:
In some cases in which the total is not one hundred, the difference is accounted for by the percentage of roots that did not reduce the level of fusariosis in 60 days.

The high level of effectiveness that is exhibited by both PTS and PTSO in the elimination of Fusarium in the soil, even at low doses, and the good response achieved to the disinfection of roots at application doses between 500 and 1000 ppm can therefore be demonstrated.

Tests were also conducted to determine the effectiveness of PTS and PTSO against Ralstonia solanacearum, another of the principal soil pathogens that colonizes the plant intra-vascularly, causing large losses in crops such as tomatoes, potatoes and bananas.

In this case, an “in vitro” test was conducted against a strain of Ralstonia solanacearum from the ETSIA Collection of the Universidad Complutense de Madrid (Internal Ref. Strain GM1000). The products were tested in a range of concentrations from 2 ppm to 2000 ppm. The inhibition test was conducted on microtiter plates with 96 wells. The final concentration of the inoculated pathogen was 10⁴ cfu/ml over a nutrient broth treated with different concentrations of PTS and PTSO, utilizing both inoculated blanks as positive inhibition controls. After incubation, the growth was determined by means of absorbency at 490 nm in an ELISA plate reader.

On the basis of the results obtained in this test, it is apparent that both products are highly effective in inhibiting the growth of the strain in question, because both products develop a good inhibitory power at doses higher than 200 ppm.

It should be noted that, in all the tests described herein, the products applied did not cause phytotoxic effects or modification of the organoleptic properties of the fruits or crops treated (anomalous residual odors or flavors, etcetera).

Specific phytotoxicity tests have also been conducted on peppers, tomatoes, asparagus and strawberries at doses higher than those usually applied and demonstrated the absence of physiopathies or other types of damage in leaves and stems, providing corroborating evidence that the plant exhibited normal growth.

In tests with plants inoculated with mycorrhizal fungi that were sprayed in their above-ground portion with solutions of PTS and PTSO, it has been found that the plant did not suffer phytotoxicity, and that the residues that can be incorporated into the substrate do not modify the mycorrhization.

On the other hand, one of the principal preventive measures to be taken into consideration to avoid rotting is the cleaning and disinfection of all the materials, surfaces, environments and containers that may come in contact with the fruit during its handling, preservation and subsequent sale.

This problem is widespread in the entire food processing industry, but it is especially serious in the case of pallets and storage containers that are used to hold harvested products. Sometimes fruit must be kept in cold rooms for long periods of time at relatively high levels of relative humidity, which makes the appearance of fungal contamination inevitable, either originating in the field or caused by the typical post-harvest fungi.

Therefore tests have been conducted to verify the effectiveness of the compounds PTS and PTSO as environmental disinfecting agents in the food processing industry, and more specifically in the rooms of a fruit and vegetable processing plant, including a verification of the effectiveness of the compounds PTS and PTSO as environmental disinfection agents in food processing industries, and more specifically in rooms of a fruit and vegetable processing plant. Therefore both products represent an effective alternative to conventional chemical agents (formol, glutaraldehyde, didecyldimethylammonium chloride, peroxides, etc.) with the added advantage that, in contrast to these latter products, PTS and PTSO can come into contact with the food.

In addition, under the real conditions of a disinfecting bath for boxes, crates and containers, as well as for the disinfection of rooms and work surfaces, organic material (soil residue, rotten fruit, leaves etc.) is generally present, which can reduce the action of the disinfectant agent. Therefore, the effectiveness of PTS and PTSO has also been assessed in the presence of organic matter on two pathogens that cause post-harvest rot of stone fruit (Penicillium expansum) and citrus fruit (Penicillium digitatum).

The pathogens were added to a suspension that made it possible to achieve a final concentration of 10³ spores/ml. The following table presents the results obtained, expressed as a percentage of reduction of spores, after 0, 1, 2, and 3 hours of agitation in the absence or presence (5 g/l every 30 minutes) of organic matter.

TABLE 11
Influence of the organic matter on the effectiveness of PTS and
PTSO against Penicillium expansum and P. digitatum

| | | | Reduction of the population (%) | | | |
|---|---|---|---|---|---|---|
| | | Organic | 0 | | | |
| Product | Pathogen | matter | hours | 1 hour | 2 hours | 3 hours |
| PTS | Penicillium | Absence | 68 | 82 | 45 | 68 |
| 750 ppm | expansum | Presence | 73 | 41 | 36 | 18 |
| 1 min. | Penicillium | Absence | 100 | 100 | 100 | 100 |
| | digitatum | Presence | 100 | 100 | 100 | 100 |
| PTSO | Penicillium | Absence | 100 | 100 | 100 | 100 |
| 2000 ppm | expansum | Presence | 100 | 100 | 100 | 85 |
| 1 min. | Penicillium | Absence | 100 | 100 | 100 | 100 |
| | digitatum | Presence | 100 | 100 | 100 | 100 |

It can be observed that the presence of organic matter alone has a significant effect on the effectiveness of PTS against Penicillium expansum, but not against Penicillium digitatum or, in any case when the disinfecting agent is PTSO, which verifies the disinfecting effectiveness of the compound, even in the presence of organic matter.

In summary, the invention proposes the application of propyl propylthiosulfinate and propylthiosulfonate compounds, natural derivatives that are present in plants of the family Alliaceae, as an effective alternative to synthetic agricultural chemicals, for the prevention and control of crop diseases and post-harvest rotting, as well as for disinfection treatments of the environment and agricultural soils.

In concrete terms, the compounds claimed by the invention are suitable for crop treatments for the prevention and control of pre-harvest diseases of crops; for the control of rotting in fruit and vegetables, to prolong their shelf life (during the phases of storage, transport and sale); in disinfection treatments of agricultural soils, for the control of microorganisms and other biotic factors that affect crops; in environmental disinfection treatments for food processing industries, both for facilities (rooms, greenhouses, etc.) and for machinery and equipment that may come into contact with the food; in disinfection treatments of boxes, crates and containers (made of wood, plastic and other materials) for the storage of fruits and other foods.

The propyl propylthiosulfinate and propyl propylthiosulfonate compounds can be applied as pure active principles or in mixtures, in aqueous solutions, in emulsions or, in general, in any formulation, both in the liquid state or supported in a solid agent or formulation, and can be applied as single active principles or in a formulation together with other synthetic or natural antifungal agents, biocontrol agents, coating agents, fertilizers, antioxidants, growth regulators or regulators of any other type, as well as by means of immersion, fogging, wetting, spraying, atomization, injection in the soil, in irrigation systems, by means of a drencher or in general any other treatment or application system.

### DETAILED DESCRIPTION OF PREFERRED EMBODIMENTS OF THE INVENTION

The following exemplary applications are presented to illustrate distinct practical uses of the product and to illustrate the invention clearly and in detail, although the invention is by no means limited to these examples.

### EXAMPLE 1

### Assessment of the Effectiveness of PTS and PTSO in the Control of Post-Harvest Rotting of Oranges

This example considers the effectiveness of the active natural principles PTS and PTSO in two different doses for the control of post-harvest rotting of oranges (Navelina variety), caused by controlled artificial inoculation with the fungi Penicillium digitatum, Penicillium expansum, Phytophthora citrophthora and Geotrichum candidum, the principal pathogens of this fruit.

The inoculation of the oranges was carried out with suspensions of spores of the different wild fungal strains selected, according to the methodology described below.

The first step was the isolation and identification of the fungal strains used in the study. The strains of filamentous fungi used in these tests (Penicillium digitatum, Penicillium italicum and Phytophthora citrophthora) were isolated from oranges affected by rot. In these isolation processes, it was not possible to detect any strain belonging to Geotrichum candidum, as a result of which it was necessary to obtain the latter substance from the Spanish Collection of Standard Cultures, where it is identified by reference CECT 1102.

For the preparation of the inocula, an initial suspension of 5*10⁷ spores/ml of the fungi mentioned above was used, and the procedure described in the ASTM G-21:1996 standard was followed. From the inocula prepared, a suspension of spores in a concentration of 5×10⁶ cfu/ml was obtained, which was applied to a crack or surface incision made with a sterile knife in the cortex of the peduncular segment of the fruit. To promote the implantation of the inoculum of Geotrichum candidum, 200 ppm of cyclohexamide was added to the inoculum prior to its inoculation.

Once the oranges had been artificially contaminated, the treatments were conducted by immersing the oranges in solutions of PTS and PTSO prepared at doses of 1600 and 2500 ppm, and were stored at 20° C.

The assessment of the effectiveness of PTS and PTSO comprised counting of the number of fruits affected by rot in the inoculated zone, to determine the percentage of fruit affected for each treatment and fungus inoculated, and expressing this effectiveness as a percentage of reduction of the affected fruit.

TABLE 1.1
Results of the test with fruit inoculated with Penicillium italicum and
treated with PTS at two different doses.

| Treatment | % of fruit affected | % Reduction |
|---|---|---|
| 7 days at 20° C. | | |
| Blank (water) | 100 | |
| 1666 ppm PTS | 0 | 100 |
| 2500 ppm PTS | 0 | 100 |
| 14 days at 20° C. | | |
| Blank (water) | 100 | |
| 1600 ppm PTS | 28 | 72 |
| 2500 ppm PTS | 15 | 85 |

TABLE 1.2
Results of the test with fruit inoculated with Penicillium italicum and
treated with PTSO at two different doses

| 4 days at 20° C. | | |
|---|---|---|
| Treatment | % of fruit affected | % Reduction |
| Blank (water) | 100 | |
| 1600 ppm PTS | 20 | 80 |
| 2500 ppm PTS | 15 | 85 |

TABLE 1.3
Results of the test with fruit inoculated with Penicillium digitatum and
treated with PTS at two different doses

| Treatment | % of fruit affected | % Reduction |
|---|---|---|
| 7 days at 20° C. | | |
| Blank (water) | 100 | |
| 1666 ppm PTS | 77 | 23 |
| 2500 ppm PTS | 47 | 53 |
| 14 days at 20° C. | | |
| Blank (water) | 100 | |
| 1600 ppm PTS | 100 | 0 |
| 2500 ppm PTS | 36 | 64 |

TABLE 1.4
Results of the test with fruit inoculated with Penicillium digitatum and
treated with PTSO at two different doses.

| | % of fruit affected | % Reduction |
|---|---|---|
| 5 days of treatment | | |
| at 20° C. | | |
| Treatment | | |
| Blank (water) | 100 | |
| 1600 ppm PTS | 28 | 72 |
| 2500 ppm PTS | 15 | 85 |
| 7 days of treatment | | |
| at 20° C. | | |
| TREATMENT | | |
| Blank (water) | 100 | |
| 1600 ppm PTS | 60 | 40 |
| 2500 ppm PTS | 43 | 57 |

From the data presented in the above tables, it can be deduced that the compound PTS is very effective against Penicillium digitatum because, when it is applied to previously inoculated oranges; it reduces rotting by up to 64% at a dosage of 2500 ppm after 14 days of application. Against Penicillium italicum, the reduction is up to 100%, even at a lower dose (1660 ppm), and remains at 85% after two weeks.

The compound PTSO is very effective against Penicillium digitatum because, under the application conditions described above, it reduces rotting by 85% at a dose of 2500 ppm, and by 72% at a dose of 1660 ppm, and keeps these values at 40% and 57% respectively 7 days after the treatment. Against Penicillium italicum, the reduction is 80% at a dose of 1660 ppm and 85% at 2500 ppm, although its longer-term results are not as effective.

TABLE 1.5
Results of the test with fruit inoculated with Geotrichum candidum and
treated with PTS at two different doses.

| Treatment | % of fruit affected | % Reduction |
|---|---|---|
| 7 days at 20° C. | | |
| Blank (water) | 100 | |
| 1600 ppm PTS | 5 | 95 |
| 2500 ppm PTS | 0 | 100 |
| 14 days at 20° C. | | |
| Blank (water) | 100 | |
| 1600 ppm PTS | 63 | 37 |
| 2500 ppm PTS | 63 | 37 |

TABLE 1.6
Results of the test with fruit inoculated with Phytophthora citrophthora
and treated with PTS at two different doses

| Treatment | % of fruit affected | % Reduction |
|---|---|---|
| 4 days of treatment | | |
| at 20° C. | | |
| Blank (water) | 78 | |
| 1600 ppm PTS | 18 | 60 |
| 2500 ppm PTS | 8 | 70 |
| 7 days of treatment | | |
| at 20° C. | | |
| Blank (water) | 100 | |
| 1600 ppm PTS | 93 | 7 |
| 2500 ppm PTS | 80 | 20 |

As noted above, the compound PTS is fairly effective against Geotrichum candidum, achieving reduction levels of 37% under the described conditions at a dose of 1660 ppm. Against Phytophthora citrophthora, PTS is moderately active, reducing rotting by 70% at a dose of 2500 ppm, and achieving a reduction of 20% one week after treatment.

TABLE 1.7
Results of 200 fruits originating directly from the field (not inoculated)
and treated with PTS and PTSO.

| Oranges refrigerated | |
|---|---|
| for 28 days at 5° C. | |
| TREATMENT | % of fruit affected |
| Water | 23 |
| 1666 ppm PTS | 10 |
| 2500 ppm PTSO | 15 |

On the basis of the results obtained by the application of PTS and PTSO to oranges of the Navelina variety originating directly from the field, both products, applied in the specified doses, are effective in the control of post-harvest rot. Both PTS and PTSO in turn reduce by 50% the quantity of fruit affected at the end of the refrigeration period (28 days at a temperature of 5° C.) compared to the untreated fruit, as a result of which they are an effective alternative to the synthetic treatments conventionally used.

As an overall conclusion, the effectiveness of both compounds in the control of post-harvest rot caused by different fungi characteristic of citrus fruit has been demonstrated, both in the case of fruit contaminated artificially by means of controlled inoculations and in the case of other fruit collected directly from the field. In this sense, both active principles have the effect of slowing the growth of these fungi during post-harvest storage and preservation.

### EXAMPLE 2

### Assessment of the Effectiveness of PTS in the Control of Post-Harvest Rotting of Tree Fruit: Apples and Pears

The effectiveness of the active principle PTS (in various individual doses) was studied in the control of post-harvest rotting of pears and apples caused by the fungi Botrytis cinerea and Penicillium expansum, the principal agents of diseases in these fruits. These phytopathogens can appear in fruit being stored in a cold room and, once in the processing plant and in a later phase, form colonies and are transferred from one fruit to another by contact.

The study was performed by means of a controlled inoculation test to ensure a high percentage of affected fruits, and to guarantee that this level of infection is with certainty caused by these pathogens, thereby making it possible to detect and evaluate significant differences between the different treatments.

The purpose of the test was to determine the effectiveness of the compound in this application and to verify the tolerance of the product in sweet fruit, both in pears (Decana and Flor de Invierno varieties) and in apples (Golden Delicious and Red Chief varieties). For this purpose, a number of different fruits of each of the varieties and treatments were selected at random.

To perform the controlled inoculation, wild strains of Botrytris cinerea and Penicillium expansum were used which were isolated in fruit and vegetable processing plants. After the isolation and identification of the strains, suspensions of known concentrations of these collected fungi were prepared in a 1% propylene glycol solution, resulting in a suspension on the order of 10⁵ spores/ml. After making incisions in the fruit 8 mm in diameter and 2 mm deep, the inoculation was performed with suspensions of specified spores. After that, the inoculated fruit was held for 8 hours at 25° C. and 60% relative humidity, allowing the fungal colonization.

After the time indicated above had passed, the various post-harvest treatments were carried out by means of drenchers at 25° C. for 60 seconds. The doses of the active principle PTS applied were in the range of 500 to 1700 ppm. A positive control was also introduced in the form of imazalil sulfate (a synthetic fungicide widely used in food processing plants for the control of pathogenic fruit fungi).

After 15 days of refrigeration of the treated fruit at 5-6° C., the test results were determined by counting the number of fruits affected. The presence of physiopathies caused by the treatments was also determined, as well as other potential effects (change of color, odor, flavor, blemishes etc.).

The test results are presented below:

TABLE 2.1
Results of the effectiveness of PTS against Botrytis cinerea in pears.

| | | | | | Phytotoxicity | |
|---|---|---|---|---|---|---|
| | No. of fruits | | % of fruit | | (number of | |
| | treated | | affected | | damaged fruits) | |
| | | Flor de | | Flor de | | Flor de |
| Treatment | Decana | invierno | Decana | invierno | Decana | invierno |
| PTS | 75 | 75 | 0% | 3.5% | 0 | 0 |
| (500 ppm) | | | | | | |
| PTS | 73 | 82 | 0% | 0.4% | 0 | 0 |
| (666 ppm) | | | | | | |
| PTS | 60 | 76 | 1% | 3.7% | 0 | 0 |
| (833 ppm) | | | | | | |
| PTS | 63 | 80 | 0.5% | 3% | 0 | 0 |
| (1666 ppm) | | | | | | |
| IMAZALIL | 56 | 73 | 19% | 24% | 0 | 0 |
| SULFATE | | | | | | |
| (450 ppm) | | | | | | |
| BLANK | 64 | 80 | 98% | 98% | 0 | 0 |

TABLE 2.2
Results of the effectiveness of PTS against Botrytis cinerea in apples.

| | | | | | Phytotoxicity | |
|---|---|---|---|---|---|---|
| | No. of fruits | | % of fruit | | (number of | |
| | treated | | affected | | damaged fruits) | |
| | Golden | Red | Golden | Red | Golden | Red |
| Treatment | Delicious | Chief | Delicious | Chief | Delicious | Chief |
| PTS | 82 | 81 | 0.5% | 1% | 0 | 0 |
| (500 ppm) | | | | | | |
| PTS | 77 | 76 | 0% | 0% | 0 | 0 |
| (666 ppm) | | | | | | |
| PTS | 81 | 82 | 1% | 1.5% | 0 | 0 |
| (833 ppm) | | | | | | |
| PTS | 82 | 79 | 0% | 0% | 0 | 0 |
| (1666 ppm) | | | | | | |
| IMAZALIL | 83 | 67 | 10% | 12% | 0 | 0 |
| SULFATE | | | | | | |
| (450 ppm) | | | | | | |
| BLANK | 76 | 71 | 92% | 94% | 0 | 0 |

TABLE 2.3
Results of the effectiveness of PTS against Penicillium expansum in pears.

| | | | | | Phytotoxicity | |
|---|---|---|---|---|---|---|
| | No. of | | % of fruit | | (number | |
| | fruits treated | | affected | | of damaged fruits) | |
| | | Flor de | | Flor de | | Flor de |
| Treatment | Decana | invierno | Decana | invierno | Decana | invierno |
| PTS | 70 | 69 | 0% | 3.6% | 0 | 0 |
| (500 ppm) | | | | | | |
| PTS | 76 | 80 | 2% | 2.2% | 0 | 0 |
| (666 ppm) | | | | | | |
| PTS | 75 | 80 | 0% | 2.4% | 0 | 0 |
| (833 ppm) | | | | | | |
| PTS | 62 | 78 | 3% | 5.3% | 0 | 0 |
| (1666 ppm) | | | | | | |
| IMAZALIL | 75 | 70 | 4.5% | 6.7% | 0 | 0 |
| SULFATE | | | | | | |
| (450 ppm) | | | | | | |
| BLANK | 69 | 77 | 98% | 99% | 0 | 0 |

TABLE 2.4
Results of the effectiveness of PTS against
Penicillium expansum in apples.

| | | | | | Phytotoxicity | |
|---|---|---|---|---|---|---|
| | No. of | | % of fruit | | (number of | |
| | fruits treated | | affected | | damaged fruits) | |
| | Golden | Red | Golden | Red | Golden | Red |
| Treatment | Delicious | Chief | Delicious | Chief | Delicious | Chief |
| PTS | 75 | 79 | 1.4% | 2.8% | 0 | 0 |
| (500 ppm) | | | | | | |
| PTS | 68 | 70 | 0.5% | 0% | 0 | 0 |
| (666 ppm) | | | | | | |
| PTS | 77 | 77 | 2.5% | 3.2% | 0 | 0 |
| (833 ppm) | | | | | | |
| PTS | 80 | 67 | 0.7% | 2.4% | 0 | 0 |
| (1666 ppm) | | | | | | |
| IMAZALIL | 67 | 74 | 4.3% | 6.2% | 0 | 0 |
| SULFATE | | | | | | |
| (450 ppm) | | | | | | |
| BLANK | 84 | 76 | 92% | 96% | 0 | 0 |

Consequently, the greater effectiveness of the product in the control of the specified types of rot can be assessed in relation to other commercial products such as imazalil sulfate. The results also verify the non-phytotoxicity of the active principle PTS and the tolerance of the fruit for PTS.

### EXAMPLE 3

### Assessment of the Effectiveness of PTS in the Control of Botrytis in Strawberries

The effectiveness of PTS in the control of Botrytis cinerea was tested in strawberries from the area of Huelva (Spain), which were affected by this gray rot in the percentages indicated in the table of results.

The test field was divided into 6 parcels and each parcel contained two rows of between 15 and 20 plants (with the corresponding passageways and protection parcels). Of the 6 parcels, one was left untreated and another was treated with a standard commercial product for the control of these pathogens in strawberries, i.e. Teldor 50% (fenhexamid). The rest of the parcels were treated with different doses of PTS.

The application was performed by means of foliar spraying, securing a proper distribution of the sprayed liquid. The application was performed using a sprayer lance and a volume of liquid which varied between 800 and 2000 liters/hectare (depending on the growth of the plants). The test protocol was carried out according to the EPPO* guidelines and in compliance with Standard FREUN0703.

The effectiveness of the treatments applied was assessed after 12 days by counting the number of fruits affected. The data are presented in Table 3.1.

TABLE 3.1
Results of the effectiveness of PTS against Botrytis in strawberries.

| | | | | No. of | | |
|---|---|---|---|---|---|---|
| | | Dose | No. of | fruits | % of fruit | Average |
| Parcel | Treatment | (ppm) | fruits | affected | affected | strength |
| 1 | Control | | 151 | 11 | 7.2 | 6.25 |
| 2 | PTS | 2000 | 150 | 6 | 3.8 | 6.25 |
| 3 | PTS | 2400 | 148 | 5 | 3.1 | 6.5 |
| 4 | PTS | 4800 | 141 | 4 | 3.1 | 7 |
| 5 | PTS | 9600 | 114 | 2 | 2 | 6 |
| 6 | Teldor ® | 1500 | 118 | 3 | 2.4 | 6.5 |
| | 50% | | | | | |

It was demonstrated that at doses higher than 2000 ppm, the product reduces the number of fruits affected by more than 50%, maintaining a crop strength equal to that achieved after the application of Teldor®, and without symptoms of phytotoxicity in the plant.

The EPPO directives followed are: PP 1/16 (Botrytis cinerea on strawberries), PP 1/135 (Assessment of phytotoxicity), PP 1/152 (Design and analysis of efficacy evaluation trials) and PP 1/181 (Conducting and reporting of efficacy evaluation trials, including good experimental practice).

### EXAMPLE 4

### Environmental Control of Critical Points in Fruit and Vegetable Processing Industries by Fogging with a Compound PTS Solution

A study was conducted to verify the environmental disinfecting capability of the compound PTS in rooms of a fruit and vegetable processing plant, in particular one that handled bananas. For test purposes, three separate rooms of the central were sampled, and the environmental quality was studied before and after the treatment with PTS.

First, an environmental sample was taken in each room prior to the treatment, using an Airtest-Omega air sampling device manufactured by LCB, by suctioning a volume of air set at 80 L which impacted over the different cultivation media selected. The samples were taken in duplicate in the areas to be analyzed. PCA agar medium was used to count the total mesophilic aerobes, and the medium Rose Bengal agar was used to count the fungi.

The environmental disinfectant treatment comprised fogging of a 1500 ppm solution of PTS. 5 liters of this solution were fogged for each 1000 m³ of the room. The fogger used was the “NEBUROTOR” fogger manufactured by Copyr s.p.a., which produces a droplet size less than ten microns, thereby allowing an intimate contact and a more effective treatment. Several hours after the fogging, the sampling operation was repeated in the different rooms that had been treated as described above.

Once the samples had been taken, the Petri dishes were incubated at 30° C. for 72 hours (dishes corresponding to total mesophilic aerobes collected on PCA) and at 25° C. for 3-7 days (one dish for each fungus, collected on Rose Bengal agar).

Once the incubation time had elapsed, the readings were taken by counting the microorganisms that appeared in each type of dish, expressed as cfu/dish. The results were processed using conversion tables, and after applying the corresponding correction factor the results were extrapolated from cfu/dish to cfu/m³. The data obtained in these analyses are presented in the following table:

TABLE 4.1
Test results on the effectiveness of PTS in the disinfection of a room
used for the storage and ripening of bananas.

| | | | | | | % REDUCTION OF | |
|---|---|---|---|---|---|---|---|
| | | MICROBE COUNTS | | | | ENVIRONMENTAL | |
| | VOLUME | | | Total | | MICROBIOTA | |
| | OF AIR | | | mesophilic | | | Population |
| | (liters | FUNGI | | AEROBES | | | of |
| ZONE | collected/ | CFU/ | | CFU/ | | Fungal | total mesophilic |
| SAMPLED | dish) | dish | CFU/m³ | dish | CFU/m³ | population | aerobes |
| Entry room | 80 | 134 | 2353 | 62 | 881 | 70% | 65% |
| before | | | | | | | |
| treatment | | | | | | | |
| Entry room | 80 | 51 | 707 | 24 | 314 | | |
| after | | | | | | | |
| treatment | | | | | | | |
| Zone 1 of the | 80 | 27 | 355 | 64 | 914 | 23% | 69% |
| ripening | | | | | | | |
| room* before | | | | | | | |
| treatment | | | | | | | |
| Zone 1 of the | 80 | 21 | 273 | 22 | 287 | | |
| ripening | | | | | | | |
| room after | | | | | | | |
| treatment | | | | | | | |
| Zone 2 of the | 80 | 38 | 512 | 174 | 3565 | 36% | 58% |
| ripening | | | | | | | |
| room* before | | | | | | | |
| treatment | | | | | | | |
| Zone 2 of the | 80 | 25 | 328 | 96 | 1487 | | |
| ripening | | | | | | | |
| room after | | | | | | | |
| treatment | | | | | | | |

*Zone 2 of the ripening room is where the pallets with the fruit are stored; no fruit is stored in Zone 1 of this room, as a result of which the level of contamination in the two zones is different.

The following conclusions can be derived from the data presented in this table:

Entry room: Before treatment, measurements in the environment showed a level of contamination by fungi and a normal level of contamination by bacteria. After the environmental treatment had been applied, there was a significant reduction in the mixed microbiota detected, and a reduction by up to 70% of the fungal population, resulting in normal levels of contamination for this type of room.

Ripening room, Zone 1: Initially, the level of contamination was normal, both for fungi and for bacteria. After performing the environmental treatment described above, there was a reduction in both microbiological groups, by 69% in the case of total mesophilic aerobes. This reduction resulted in a relatively uncontaminated environment with an acceptable environmental quality.

Ripening room, Zone 2: Before the treatment, a mixed microbiota was detected, with a predominance of bacteria, which reached levels corresponding to a highly contaminated environment. The initial environmental quality was therefore unacceptable. After performing the treatment with PTS, microbial levels were reduced from a level of high contamination to normal contamination.

Given the major reductions in microbes detected in the different environmental treatments performed with PTS under the conditions described above, the effectiveness of this compound for the environmental disinfection of refrigerated storage rooms has been deduced, along with their usefulness in post-harvest control in such storage rooms.

### EXAMPLE 5

### Application of PTS and PTSO in Disinfection by Means of Drenchers of Containers of Fruit with a Known Level of Contamination

### 5.1—Disinfection of Containers by Means of Drenchers

A test of the disinfection of containers (fruit boxes and crates) was conducted in which a level of artificial contamination was created by means of controlled inoculation, with the objective of determining optimum doses of application to achieve a satisfactory disinfection.

First the containers (made of wood and plastic) were disinfected with sodium hypochlorite, and they were then artificially contaminated via controlled inoculations with different fungi characteristic of the fruit and vegetable processing sector. For this purpose, isolated wild strains were used which, after sporulation, were collected to create a suspension of mixed spores of various fungi (Penicillium expansum, Penicillium italicum, Penicillium digitarum and Alternario alternata) and, separately in simultaneous tests (as a result of its higher rate of growth and its invasive character), a suspension of Rhizopus stolonifer.

The contamination was achieved by fogging the solutions of spores of the above referenced fungi at a concentration of 10⁴ spores/ml, which produces a level of contamination similar to what is found naturally in fruit and vegetable processing plants. After this fogging, the containers were allowed to dry. The containers were then sampled to determine the level of initial contamination achieved (by means of contact plates containing Rose Bengal agar).

The containers were then treated in a pilot line drencher. The hold time of the containers under the showers was 30 seconds, and the test doses were 750 ppm and 1050 ppm for PTS and 2000 ppm and 5000 ppm in the case of PTSO. After exiting the showers, the treated containers were allowed to dry, and were again sampled using contact plates with Rose Bengal agar to determine the final level of contamination. The sampling unit was 3 containers and 3 plates per repetition.

The results obtained in this disinfection test using the drencher on containers with a known level of contamination are presented in TABLE 5.1:

TABLE 5.1
Test results: Effectiveness of PTS and PTSO in the disinfection of
artificially contaminated wooden and plastic containers.

| | Dose of active | | Reduction of the | |
|---|---|---|---|---|
| | principle | | population (%) | |
| Product | (ppm) | Container | Fungi mixture* | R. stolonifer |
| PTS | 750 | Wood | 85 | 94 |
| | | Plastic | 81 | 100 |
| | 1050 | Wood | 85 | 100 |
| | | Plastic | 87 | 99 |
| PTSO | 2000 | Wood | 98 | 96 |
| | | Plastic | 93 | 100 |
| | 5000 | Wood | 99 | 98 |
| | | Plastic | 93 | 100 |

*The mixture of pathogenic fungi contains 3 types of Penicillium (P. expansum, P. italicum and P. digitatum) and A. Alternata.

The data presented in the above table show the great effectiveness of both products in the reduction of contamination of the containers, both against the mixture of fungi and Rhizopus stolonifer in particular. The latter is one of the most feared fungi in the fruit and vegetable processing sector as a result of its highly aggressive characteristics and rate of dissemination, as a result of which the data obtained are of special relevance if we recall that the Mucorales (the order to which R. stolonifer belongs) have a high resistance to conventional disinfectant treatments, as a result of which the products described in this patent can be an ideal alternative because of their level of effectiveness.

5.2—Disinfection by Fogging of Rooms and Containers Located in them that have been Artificially Contaminated

This test, which was conducted under pilot plant conditions (reproducing actual plant conditions), comprised the disinfection of a room and of the containers (made of wood and plastic) located inside it.

For the test, and as in the previous case, a level of fungal contamination similar to that normally found in fruit and vegetable plants was created. The artificial inoculations were carried out using suspensions of spores of the above referenced mixture of fungi (Alternaria alternata and three species of Penicillium), and making in parallel but separate tests controlled inoculations with Rhizopus solonifer. The tests were conducted in the manner described above, taking samples from plates of Rose Bengal agar before and after the treatments were carried out.

In these tests, the disinfecting treatments (disinfection of the environment and of containers) were performed by means of fogging using the “NEBUROTOR” fogger (Copyr s.p.a.) with solutions of PTS at 750 and 1050 ppm, and of PTSO at 2000 ppm. To conduct the room treatments, 125 ml of each of the test solutions was fogged for each room. The volume of each room was 25 m³. The fogging time for each dose and room was 1 minute and 25 seconds.

The different treatments were allowed to dry and the final concentration was determined by means of contact plates with Rose Bengal agar. The sampling unit was 3 repetitions (3 plates) for each concentration studied for each point sampled, i.e. walls and environment of the room, and wooden and plastic containers.

The following tables present the results obtained in the test:

TABLE 5.2
Effectiveness of PTS and PTSO in the disinfection of rooms by means
of fogging.

| | | | Reduction in the |
|---|---|---|---|
| | | | population of the |
| | Dose (ppm) of | Zone of the | mixture of fungi* |
| Product | active principle | room | expressed in % |
| PTS | 750 | Walls | 96 |
| | | Environment | 89 |
| | 1050 | Walls | 97 |
| | | Environment | 100 |
| PTSO | 2000 | Walls | 95 |
| | | Environment | 100 |
| | 5000 | Walls | 100 |
| | | Environment | 100 |

*The mixture of pathogenic fungi contains 3 types of Penicillium (P. expansum, P. italicum and P. digitatum) and A. alternata.

TABLE 5.3
Effectiveness of PTS and PTSO in the disinfection of containers stored
inside the rooms after fogging both products at different test doses.

| | | | Reduction of the | |
|---|---|---|---|---|
| | Dose of active | | population (%) | |
| | principle | | | Rhizopus |
| Product | (ppm) | Container | Fungi mixture* | stolonifer |
| PTS | 750 | Wood | 97 | — |
| | | Plastic | 97 | 36 |
| | 1050 | Wood | 97 | 26 |
| | | Plastic | 98 | 27 |
| PTSO | 2000 | Wood | 67 | 78 |
| | | Plastic | 94 | 77 |
| | 5000 | Wood | 70 | 56 |
| | | Plastic | 92 | 71 |

*The mixture of pathogenic fungi contains 3 types of Penicillium (P. expansum, P. italicum and P. digitatum) and A. alternata.

As noted above, the effectiveness of the products is very high in both cases, although the disinfection in the wooden containers is higher with PTS than with PTSO (the results are similar in plastic). The reduction of the population of Rhizopus stolonifer is less than that observed in the rest of the pathogens, although PTSO achieved very large levels of reduction of the pathogen.

It was also verified that, in this case of disinfection of containers by means of fogging, the effectiveness is less than that obtained in the liquid disinfection of the containers (by means of a drencher). This fact is normal in the effectiveness of disinfectant products applied by fogging, because the contact and penetration are less than can be achieved with liquid application. Nevertheless, the level of disinfection is very high for both PTS and PTSO.

### EXAMPLE 6

### Effectiveness of PTS and PTSO for Disinfection of Naturally Contaminated Containers by Means of a Drencher

A test was conducted under real conditions of contamination of a citrus fruit processing plant, on naturally contaminated containers that were used in the harvesting and storage of citrus fruit in the previous campaign.

The procedure used to conduct the test is explained below.

After determining the initial contamination of the pallets and preparing the treatment liquid, the pallets were disinfected in the drencher of the processing plant. The disinfected pallets were allowed to drain and dry, and after 24 hours the final contamination was determined (by means of contact plates with RBCA—Rose Bengal Chloramphenicol). Samples were taken (in triplicate) from the first foot of the washed pallets and from the eighth foot, to study the differences in the effectiveness of the treatment with the passage of time and of the containers. 3 plates were taken from each container (two from the bottom and another from the sides).

The results obtained are presented in the following table:

TABLE 6.1
Effectiveness of PTS and PTSO in disinfection by means of
drencher on naturally contaminated containers.

| | | Reduction of the fungal | |
|---|---|---|---|
| | | population (%) | |
| Product | Area of the pallet | Beginning of bath | End of bath |
| PTS | Side | 97 | 100 |
| 750 mm | Bottom | 87 | 79 |
| PTSO | Side | 100 | 87 |
| 2000 ppm | Bottom | 93 | 96 |

As can be seen, the application of the proposed doses of PTS and PTSO for the disinfection of containers in the drencher achieves a reduction of the fungal population of more than 95% at the beginning of the washing process and more than 78% after all 8 feet have been washed

Therefore, it can be concluded that both products are highly effective for the disinfection of naturally contaminated containers exhibiting high levels of contamination in fruit and vegetable processing plants, and that it can be used as a natural alternative to chemical disinfectants.

1. Utilization of antimicrobial agents derived from plants of the alliaceae family for the prevention and control of crop diseases, post-harvest rotting and as environmental disinfection products, in which said agents are compounds of plants of the genus allium; and in which said compounds are propyl propylthiosulfinate (PTS) and propyl propylthiosulfonate (PTSO).

2. Utilization of antimicrobial agents derived from plants of the alliaceae family for the prevention and control of crop diseases, post-harvest rotting and as environmental disinfection products as recited in claim 1, characterized in that it is effective in treatments for the prevention and control of pre-harvest crop diseases.

3. Utilization of antimicrobial agents derived from plants of the alliaceae family for the prevention and control of crop diseases, post-harvest rotting and as environmental disinfection products as recited in claim 1, characterized in that it is effective in post-harvest treatments for the control of rot in fruits and vegetables and to prolong their shelf life (during the phases of storage, transport and sale).

4. Utilization of antimicrobial agents derived from plants of the alliaceae family for the prevention and control of crop diseases, post-harvest rotting and as environmental disinfection products as recited in claim 1, characterized in that it is effective in disinfection treatments of agricultural soils, for the control of microorganisms and other biotic factors that affect crops.

5. Utilization of antimicrobial agents derived from plants of the alliaceae family for the prevention and control of crop diseases, post-harvest rotting and as environmental disinfection products as recited in claim 1, characterized in that it is effective in environmental disinfection treatments in food processing industries, both in facilities (rooms, greenhouses, etc.) and in machinery and equipment characterized by the fact that they can come into contact with the food.

6. Utilization of antimicrobial agents derived from plants of the alliaceae family for the prevention and control of crop diseases, post-harvest rotting and as environmental disinfection products as recited in claim 1, characterized in that it is effective in disinfection treatments for containers, pallets and storage boxes and crates (made of wood, plastic or other materials) for fruit and other foods.

7. Utilization of antimicrobial agents derived from plants of the alliaceae family for the prevention and control of crop diseases, post-harvest rotting and as environmental disinfection products as recited in claim 1, characterized in that they can be applied as pure active principles or in mixtures, in aqueous solutions of any concentration, in emulsions or, in general, in any formulation, both in the liquid state or supported in a solid agent or formulation.

8. Utilization of antimicrobial agents derived from plants of the alliaceae family for the prevention and control of crop diseases, post-harvest rotting and as environmental disinfection products as recited in claim 1, characterized in that they can be applied as single active principles or in a formulation together with other synthetic or natural antifungal agents, biocontrol agents, coating agents (natural or synthetic), fertilizers, antioxidants, growth regulators or regulators of any other type.

9. Utilization of antimicrobial agents derived from plants of the alliaceae family for the prevention and control of crop diseases, post-harvest rotting and as environmental disinfection products as recited in claim 1, characterized in that they can be applied for said purposes by means of immersion, fogging, wetting, spraying, atomization, injection into the soil, in irrigation systems, by means of drenchers or, in general, any other treatment or application system.
